(19) United States
(12) Patent Application Publication
(10) Pub. No.: US 2016/0191271 A1
(43) Pub. Date: Jun. 30, 2016

(54) Control System for a Rail Vehicle

(71) Applicant: SIEMENS AKTIENGESELLSCHAFT, München (DE)

(72) Inventor: GERHARD STEINHAUER, WILLICH (DE)

(73) Assignee: SIEMENS AKTIENGESELLSCHAFT, MUENCHEN (DE)

(21) Appl. No.: 14/910,338

(22) PCT Filed: Jul. 14, 2014
(86) PCT No.: PCT/EP2014/065036

§ 371 Date: Feb. 5, 2016

(30) Foreign Application Priority Data
Aug. 9, 2013 (DE) 102013215811.4

(51) Int. Cl. H04L 12/437; H04L 12/427; B61L 15/00; H04L 12/407

(52) U.S. Cl. CPC H04L 12/437; H04L 12/407; H04L 12/427; B61L 15/0063; B61L 15/0072; H04L 2012/40293

(57) ABSTRACT

A control system for a rail vehicle with a plurality of cars has at least one central control device for controlling vehicle-wide functions based on global information, and a set of decentralized car control devices, each containing a local sub-information of the global information during operation. The control system has a redundancy which is sufficient relative to availability requirements and which is achieved cost-effectively and with minimal effort. A data connection apparatus having connection segments, which connect car control devices of adjacent cars in pairs to produce data transfer in at least one transfer direction. The paired car control devices and the connection segments form, in the transfer direction, a data chain that is cumulative in respect of the sub-information and there is at least one identifying unit which detects and evaluates data of the data chain to form the global information.

The invention relates to a control system for a rail vehicle, which has a plurality of cars, comprising at least one central control apparatus provided for controlling at least one vehicle-wide function on the basis of global information, and comprising a set of decentralized car control devices which, during operation, in each case contain a local sub-information item of the global information.

The development of a control engineering system for a rail vehicle, in particular a rail motor unit consisting of a plurality of cars, has to take account of stringent requirements made of the availability of control components. The simple failure of such a component must not restrict the traveling capability of the rail vehicle. The control functions of such a rail motor unit can be subdivided into car-local and vehicle-wide functions. Data which arise car-locally are collected and processed for the vehicle-wide functions. The failure of a local function generally remains locally limited and does not impair the traveling capability of the rail motor unit as a whole. Without a suitable measure, the failure of central functions can generally lead to the loss of the traveling capability supported by the electronic vehicle control. Usually, only emergency control without electronic vehicle control is possible in that case.

In order to avoid this, it has already been proposed to use redundant, central control systems for central functions. In the event of a failure of a central control, a redundant control performs at least the tasks which are relevant to the capability of the rail vehicle.

The invention is based on the object of providing a control system in which a sufficient redundancy with respect to availability requirements can be achieved cost-effectively and with low complexity.

For this purpose, it is proposed that
provision is made of a data connection device comprising connection segments which connect car control devices of adjacent cars to one another in pairs for the purpose of producing a data transfer in at least one transfer direction,
the paired car control devices and the connection segments form, in the transfer direction, a data chain which is cumulative with respect to the sub-information items, and
provision is made of at least one determining unit which detects and evaluates data of the data chain for the purpose of forming the global information.

As a result, with regard to faulty operation, in particular a failure of the central control apparatus or of a communication between the latter and the car control devices, it is possible to achieve an advantageous redundancy at least with respect to the determination of the global information which can be formed on the basis of at least one significant portion of the sub-information items, in particular of all the sub-information items. If, on account of the faulty operation, the central control apparatus is not able to collect the local sub-information items for forming the global information, the latter can be formed and made available by means of the determining unit. The global information can be, in particular, a quantifiable variable, wherein the local sub-information items correspond for example in each case to a fraction of said variable. The global information can be, for example, one or a combination of the information items contained in the following group: characteristic variable for an electrical power, braking effect characteristic variable, tractive force characteristic variable, speed characteristic variable, retardation characteristic variable.

Moreover, in the event of entirely satisfactory operation of the central control apparatus by means of the proposed determination—independent thereof—of the global information by means of the determining unit it is possible to achieve an increase in the so-called safety integrity level (also called “SIL”). This emerges, in particular, from the fact that in the proposed control system global information classified as relevant to safety can be determined and plausibilized by independent hardware-technological and software-technological measures.

The car control devices, which are advantageously assigned in each case to a different car, are expediently arranged in each case in the assigned car of the rail vehicle. The connection segments connect, in particular, in each case two car control devices to one another which are arranged in cars coupled mechanically and directly to one another. Cars in opposite end regions of the rail vehicle—the end cars in the case of an embodiment of the rail vehicle as a rail motor unit—can be regarded as “adjacent cars” from a data-technological standpoint by virtue of the fact that a connection segment of the data connection device can be provided for connecting the car control devices of said cars.

Each connection segment is expediently assigned transfer units which make it possible to transfer data in the at least one transfer direction between the car control devices paired by the connection segment. In this case, a transfer unit can particularly advantageously be formed at least partly by a communication interface of an assigned car control device.

Along a “data chain which is cumulative with respect to the sub-information items” a chain transfer of items of information is effected in which items of information are transferred progressively from car control device to car control device and the information content in the car control devices is extended in each case with the respective sub-information item. For this purpose, the car control devices of the data chain are in each case designed in such a way that—given the presence of a next car control device in the transfer direction—the data set to be transferred thereto takes account of at least the respective local sub-information item and—given the presence of a previous car control device in the transfer direction—the information content of the data set originating therefrom. By means of the data chain, preferably all functional car control devices—as viewed in the corresponding transfer direction—are connected in series, a data flow being produced along the data chain. With regard to the data flow, the car control devices are in each case provided for fashioning the data set to be transferred by them in the corresponding transfer direction in such a way that it contains at least the respective local sub-information item and, if appropriate, the information content of the data set obtained in said transfer direction and originating from the previous car control device. This can be achieved, in particular, by virtue of the fact that at least the car control devices arranged within the data chain in each case have a data processing unit provided for extending the data set obtained in the corresponding transfer direction with the respective sub-information item and for forwarding the extended data set in said transfer direction.

In the case of the above-described progressive transfer from car control device to car control device along a cumulative data chain in the corresponding transfer direction, the sub-information items can advantageously be collected. If said data chain is open, as a result of the chainwise transfer of the data sets advantageously all collected sub-information items—as viewed in the corresponding transfer direction—are present at the end of the chain, in particular in the car control device forming the end of the chain. It is therefore advantageous if, in accordance with one embodiment of the invention, the determining unit is assigned to said car control device and is provided for detecting and evaluating the items of information present therein.

In accordance with a further embodiment, alternatively or additionally, it can be provided that
a data transfer in a right and a left transfer direction is producible by means of the data connection device for each connection segment,
the paired car control devices and the connection segments form—in the right transfer direction—a right data chain which is cumulative with respect to the sub-information items, and—in the left transfer direction—a left data chain which is cumulative with respect to the sub-information items and
the determining unit is provided for detecting and evaluating data sets, which are transferred in both transfer directions between two paired car control devices.

It is thereby possible for the above-described collection of the sub-information items to be effected in both transfer directions. What can advantageously be achieved as a result is that the data flows at suitable locations in the left and right data chains have information contents which are complementary and from which the global information can be formed.

The terms “left” and “right” with respect to the transfer directions serve merely for differentiating between the transfer directions along the longitudinal direction of the vehicle. Their definition is independent, in particular, of an alignment and/or a direction of travel of the rail vehicle. They likewise serve for differentiating the direction of the data flows in the data chains via which preferably all functional car control devices—as viewed in the corresponding transfer direction—are connected in series.

Each connection segment is expediently assigned transfer units which make it possible to transfer data in both transfer directions between the car control devices paired by the connection segment. The transfer units can particularly advantageously be formed at least partly by a communication interface of an assigned car control device. A transfer unit can be formed structurally by a continuous device. In this case, a differentiation between a transmitting and receiving function of a transfer unit can be effected logically. This can be employed advantageously, in particular, if, in the connection segment, one line is used jointly for both transfer directions.

In one alternative embodiment, the transfer unit can be formed by elements which are spatially separated from one another and which differ from one another in their transmitting or receiving function. This can be employed advantageously, in particular, if different lines of the connection segment are provided for the transfer directions.

A detection of the data sets in the left and right data chains by the detection unit can particularly advantageously be effected in a connection segment of the data connection device. In this case, a connection segment can be chosen arbitrarily for the detection. Alternatively or additionally, a detection of the data sets in the left and right data chains by the detection unit can be effected in a car control device, wherein the latter can be chosen arbitrarily. The detection can be effected by means of a plurality of determining units, such as, in particular, in a plurality of connection segments, in a plurality of car control devices and/or in at least one connection segment and at least one car control device. In the case of a detection in a car control device, the determining unit is advantageously assigned to at least one communication interface of the car control device, said at least one communication interface being connected to a connection segment. Moreover, a plurality of detection units can be assigned to a car control device. In particular, in each case a different determining unit can be assigned to the communication interfaces of a car control device.

The at least one determining unit can be embodied separately from the car control devices. However, a structurally simple embodiment can be achieved if the at least one determining unit is at least partly a constituent part of one of the local car control devices. This is suitable, in particular, for a detection of the data sets within the car control device.

Moreover, it is proposed that at least one of the car control devices is provided for implementing the vehicle-wide function on the basis of the global information formed by means of the determining unit. It is thereby possible to extend the redundancy beyond the determination of the global information to the implementation of the vehicle-wide function. In this case, a second, redundant central control apparatus can advantageously be dispensed with. It is thereby possible to save costs, weight and power consumption of said redundant control and cabling required therefor.

Said at least one car control device is expediently connected to the at least one determining unit, wherein the connection serves for making the global information formed by the detection unit available for the assigned car control device. In particular, the determining unit can be at least partly a constituent part of said at least one car control device.

As a result, an image of items of information of the entire vehicle can be made available to the at least one car control device, as a result of which essential vehicle-wide functions can be realized therein.

The redundancy can additionally be increased further if, in the control system, provision is made of a set comprising a plurality of the car control devices, wherein the latter are in each case provided for implementing the vehicle-wide function. In one particularly advantageous embodiment, all car control devices are to be embodied for implementing the vehicle-wide function.

In this connection it is proposed that the control system has a plurality of determining units which are assigned in each case to a different car control device of the set.

In one advantageous development of the invention, the car control devices can be networked with one another in a ring-shaped topology by means of the data connection device. This can expediently be achieved by means of a connection segment of the data connection device which as necessary—in particular in the event of faulty operation of one of the car control devices and/or of one of the connection segments—directly connects the car control devices of cars arranged in opposite end regions of the rail vehicle to one another. As a result, a left and/or a right data chain can be formed via said connection segment in this fault situation.

Furthermore, it is proposed that the control system has a vehicle data bus, which connects the car control devices and the central control apparatus to one another, wherein the data connection device is different than the vehicle data bus. It is thereby possible to achieve an advantageous redundancy with regard to a failure of the vehicle data bus.

In accordance with one advantageous embodiment of the invention, the determining unit is provided for forming a sum of the information items contained in the detected data. This is suitable in particular for an application in which the global information is a quantifiable variable.

There is furthermore proposed a method for controlling a rail vehicle which has a plurality of cars, at least one central control apparatus provided for controlling at least one vehicle-wide function on the basis of global information, and a set of decentralized car control devices which, during operation, in each case contain a local sub-information item of the global information, wherein
car control devices of adjacent cars are connected to one another in pairs by means of connection segments of a data connection device,
for each connection segment a data transfer is effected between the car control devices paired by the connection segment in at least one transfer direction,
the paired car control devices and the connection segments form, in the transfer direction, a data chain, which is cumulative with respect to the sub-information items, and
data of the data chain are detected and evaluated and the global information is formed on the basis of the data.

For the advantageous effects of the proposed method, reference is made to the explanation above with regard to the control system.

The formation of a data chain which is cumulative with respect to the sub-information items expediently comprises the following step: the car control devices in the data chain progressively receive—given the presence of a car control device arranged upstream in the transfer direction—in each case a data set in the transfer direction and transfer—given the presence of a car control device arranged downstream in the transfer direction—a further data set thereto, wherein the data set to be transferred takes account of at least the respective local sub-information item and—given the presence of the data set received in the transfer direction—the information content thereof.

One exemplary embodiment of the invention will be explained with reference to the drawings, in which:

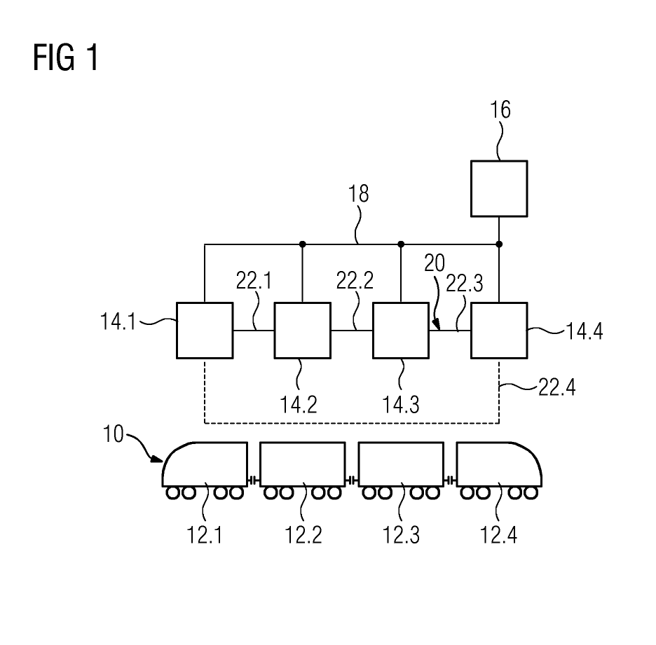

FIG. 1: shows a rail vehicle comprising a plurality of cars and an arrangement of car control devices, in a schematic side view,

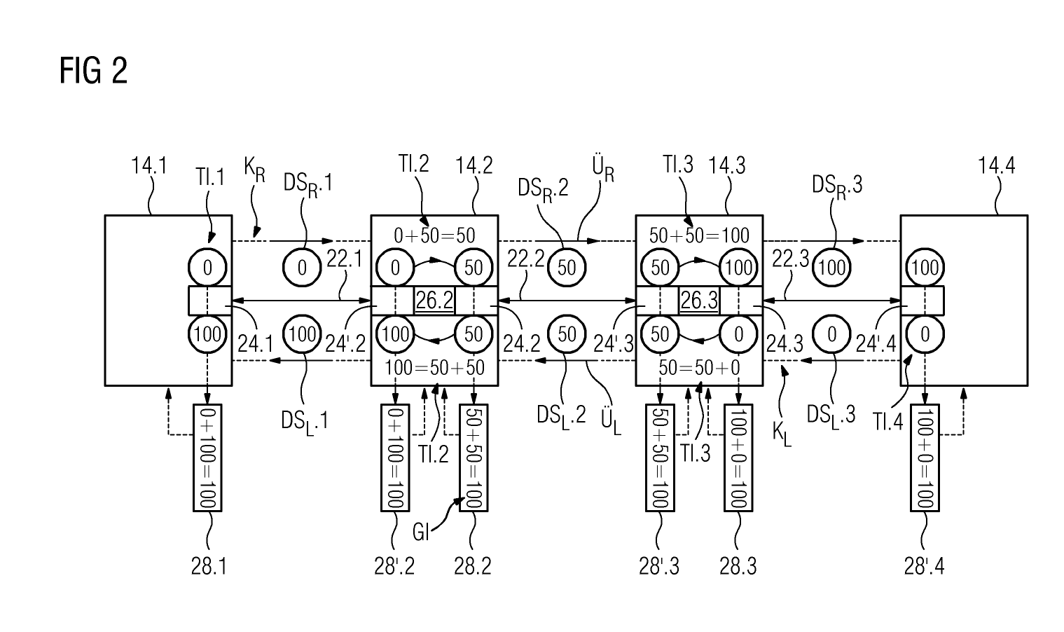

FIG. 2: shows the arrangement of car control devices from FIG. 1 and data chains formed by them, and

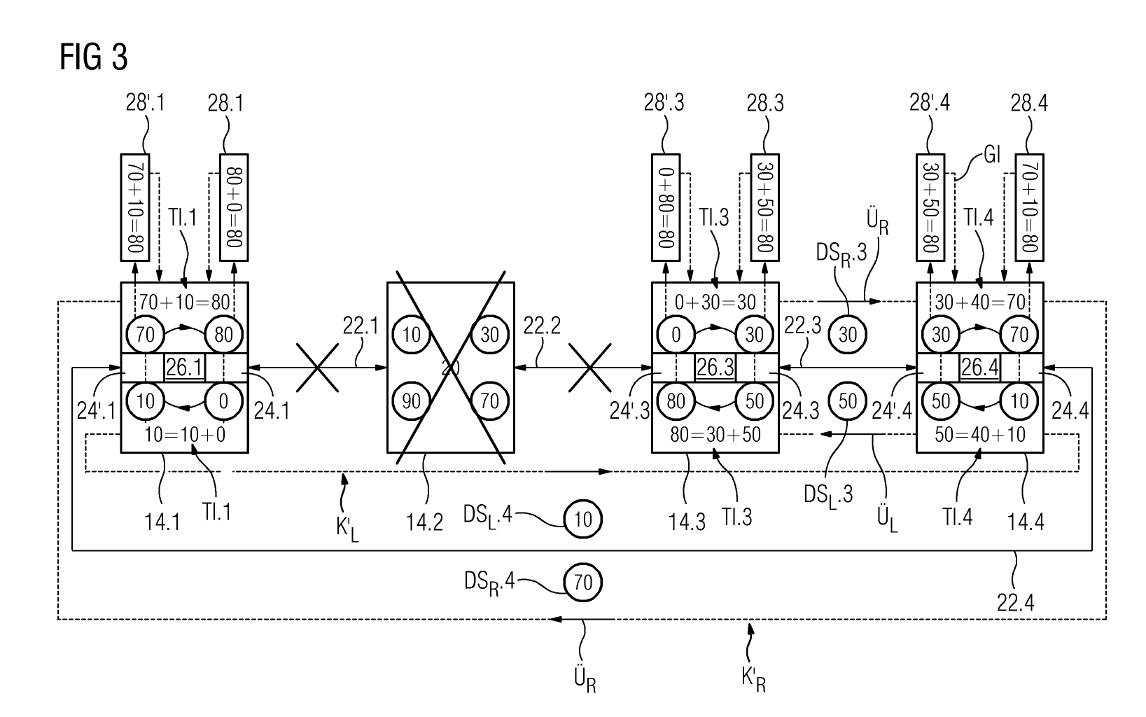

FIG. 3: shows the arrangement from FIG. 2 in the event of failure of one of the car control devices.

FIG. 1 shows a rail vehicle 10 embodied as an electrical rail motor unit in a schematic side view. It is embodied as an assembly of a plurality of cars 12.1 to 12.4 coupled to one another. Each car 12 has a multiplicity of functional components (not illustrated in more specific detail) which are controlled by a car control device 14 arranged in the respective car 12 and are connected to said car control device by control lines. For the sake of clarity, the car control device 14 is illustrated in an enlarged manner above the corresponding car 12.

The car control devices 14.1 to 14.4 of the rail vehicle 10 are connected to one another and to a central control apparatus 16 by means of a vehicle data bus 18. The vehicle data bus 18 serves to transfer data of the decentralized car control devices 14.1 to 14.4 to the central control apparatus 16 and control data of the central control apparatus 16 to the decentralized car control devices 14.1 to 14.4. The construction, the topology and the functioning of such a vehicle data bus 18 are known and will not be explained in any further detail. By way of example, the vehicle data bus can be embodied as a WTB bus (or “wire train bus”).

The control apparatus 16 is provided for implementing vehicle-wide functions. To put it another way, in terms of its functioning the central control apparatus 16 is a superordinate apparatus in relation to the local car control devices 14.1 to 14.4. Vehicle-wide functions should be understood to mean functions which are relevant to the operation of the entire rail vehicle 10, in particular the traveling capability thereof. By way of example, a vehicle-wide function can consist in vehicle-wide management of an available power. A further vehicle-wide function can be the transfer of control commands to a group of functional components which are arranged in a distributed fashion in the entire rail vehicle 10. Such a group may be part of drive and/or braking equipment or it may correspond to a specific group of consumers, such as e.g. a group of air-conditioning units, battery chargers, etc. Such vehicle-wide functions are typically implemented on the basis of global information which can be formed from a collection of local, car-related sub-information items. In the example of vehicle-wide power management, overall power related to the entire rail vehicle 10 can be formed from the powers respectively pulled up in each car 12. The car-related powers are contained as local sub-information in the respective car control device 14, which is transferred to the central control apparatus 16 via the vehicle data bus 18. Said central control apparatus collects the individual local sub-information items, forms therefrom the global information and implements a vehicle-wide function on the basis thereof.

In addition to the vehicle bus 18, provision is made of a data connection device 20, which connects the car control devices 14 of adjacent cars 12 to one another in pairs. For this purpose, it has a set of connection segments 22.1 to 22.3 which in each case connect two car control devices 14 arranged in adjacent cars 12 to one another. The connection segments 22.1 to 22.3 extend in particular in the area which is arranged between the car bodies of the adjacent cars 12. In addition, a connection segment 22.4 is optionally provided, which can connect the car control devices 14.1 and 14.4. The car control devices 14 can thereby be networked with one another in a ring-shaped topology by means of the data connection device 20. The function of the optional connection segment 22.4 is explained in greater detail below in the description concerning FIG. 3.

The arrangement of the local car control devices 14 is illustrated in greater detail in FIG. 2.

The connection segments 22.1 to 22.3 are in each case formed by a structure which is suitable for enabling a data exchange between the car control devices 14 of the respectively connected pair. For each pair of car control devices 14, provision is made of transfer units 24, 24′ which enable data to be transferred bidirectionally between the car control devices 14 of the connected pair via the assigned connection segment 22. In this regard, e.g. for the pair formed by the car control devices 14.2 and 14.3, provision is made of a first transfer unit 24.2, which is assigned to the first car control device 14.2 of the pair, and a second transfer unit 24′.3, which is assigned to the second car control device 14.3 of the pair. In particular, the transfer units 24, 24′ are formed in each case by an interface unit (referred to e.g. as “communication port” in the jargon) of the assigned car control device 14 to which the respective connection segment 22 is connected. To put it another way, said connection segment 22 connects opposite interface units of the paired car control devices 14, wherein said interface units in each case form a transfer unit 24 and 24′, respectively, for transfer via the connection segment 22. The transfer units 24.2, 24′.3 under consideration, which are connected to one another by the respective connection segment 22.2, therefore enable both a data transfer in a left transfer direction U_{L} between the second car control device 14.3 and the first car control device 14.2 of the pair and a data transfer in an opposite, right transfer direction Ü_{R} between the first car control device 14.2 and the second car control device 14.3 of the pair.

If—to summarize—there is a pair of car control devices 14 connected to one another by means of a connection segment 22, a corresponding pair of transfer units 24, 24′ is therefore provided for said pair and enables a data exchange, i.e. a data transfer in both transfer directions Ü_{L} and Ü_{R}, via the connection segment 22.

The car control devices 14 of the rail vehicle 10 form together with the connection segments 22 for each transfer direction Ü_{L} and Ü_{R} a data chain K_{L}, and K_{R}, respectively, which extends along the entire rail vehicle 10, as explained in greater detail below.

For this purpose, the car control devices 14 are in each case fundamentally provided for transmitting, for both transfer directions Ü_{R} and Ü_{L}, a data set to an adjacent car control device 14 arranged downstream as viewed in the right and left transfer directions, respectively. For this purpose, the car control devices 14 are in each case assigned two transfer units 24, 24′, which in each case face a different adjacent car control device 14. In particular, said transfer units 24, 24′ are formed in each case by a different data interface unit of the car control device 14 under consideration.

The transfer units 24.1 to 24.3 in each case face an adjacent car control device 14 arranged in the right transfer direction Ü_{R}. Therefore, they transmit data in the right transfer direction Ü_{R} and receive data in the left transfer direction Ü_{L}. The transfer units 24′.2 to 24′.4 in each case face an adjacent car control device 14 arranged in the left transfer direction Ü_{L}. Therefore, they transmit data in the left transfer direction Ü_{L} and receive data in the right transfer direction Ü_{R}.

The transfer of a data set in a transfer direction by a car control device 14 presupposes the presence of a car control device 14 which is arranged downstream in said transfer direction and which is ready to receive. In the embodiment under consideration in FIG. 2, for the car control devices 14 arranged in the end cars 12.1 and 12.4, a transfer can be effected only in one transfer direction, while for the car control devices 14 of the central cars 12.2 and 12.3, which are arranged within the data chains K_{R} and K_{L}, a transfer can take place in both transfer directions Ü_{L} and Ü_{R}.

Proceeding from the car control device 14.1 in the end car 12.1, the above-described transfers from car control device to car control device form a data chain K_{R} in the right transfer direction Ü_{R} which extends along the entire rail vehicle 10 as far as the car control device 14.4 in the end car 12.4 and connects all the car control devices 14.1 to 14.4 in series. In a similar manner, proceeding from said car control device 14.4, a data chain K₁ is formed in the left transfer direction Ü_{L} as far as the car control device 14.1. In the embodiment under consideration, both data chains K₁, and K_{R} are formed in each case as open chains and have the same ends which are formed by the car control devices 14.1 and 14.4 of the end cars 12.1 and 12.4, respectively.

As already described above, the car control devices 14 in each case contain a sub-information item TI of the global information. By way of example, a power that is available or obtained in the overall vehicle is regarded as global information GI. The local sub-information items in each case correspond to a fraction (in percent) of the total power which is obtained or available locally in the corresponding car 12. The following is assumed in the embodiment under consideration: TI.1=0, TI.2=50, TI.3=50 and TI.4=0. The global information GI corresponds to the sum of all the sub-information items TI, that is to say that GI=100 holds true.

The data sets transferred by the car control devices 14 are formed at least on the basis of the respective sub-information item TI of the corresponding car control device 14. This formation is effected as follows in the embodiment under consideration.

The car control devices 14.1 and 14.4 which are arranged in the end cars 12.1 and 12.4 and in each case form an end of the data chains K_{L}, and K_{R} transmit their respective sub-information item TI.1 and TI.4 to the adjacent car control device 14 as a data set. The car control device 14.1 transmits, by means of its transfer unit 24.1, the data set DS_{R}.1 in the right transfer direction Ü_{R} to the adjacent car control device 14.2 arranged downstream in this direction. The data set DS_{R}.1 contains the sub-information item TI.1=0. The car control device 14.4 transmits, by means of its transfer unit 24′.4, the data set DS_{L}.3 in the left transfer direction Ü_{L} to the adjacent car control device 14.3 arranged downstream in this direction. The data set DS_{L}.3 contains the sub-information item TI.4=0.

To put it more generally, in the right data chain K_{R} the transfer unit 24.i of the car control device 14.i transmits a data set DS_{R}.i to the adjacent car control device 14.i+1 arranged in the right transfer direction Ü_{R}. The data set DS_{R}.i is received by the transfer unit 24′.i+1 which is assigned to said car control device 14.i+1. In the left data chain K_{L} the transfer unit 24′.i of the car control device 14.i transmits a data set DS_{L}.(i−1) to the adjacent car control device 14.i−1 arranged in the left transfer direction Ü_{L}. The data set DS_{L}.(i−1) is received by the transfer unit 24.i−1 which is assigned to said car control device 14.i−1.

The car control devices 14.2 and 14.3 which are arranged within the data chains K_{L}, and K_{R}, i.e. the car control devices of the central cars 12.2 and 12.3 in the embodiment under consideration, in each case have a data processing unit 26.2 and 26.3, respectively, the function of which will now be described.

In relation to a transfer direction, the data processing unit 26 performs an extension of the data set received by it in the respective transfer direction with the respective sub-information item. In the embodiment under consideration, the extension corresponds to a sum formed from the acquired data set and the sub-information item.

For the car control device 14.i—relative to the right transfer direction Ü_{R}—the data set DS_{R}.(i−1) received by the corresponding transfer unit 24′.i is extended with the sub-information item TI.i. In this case, an extended data set DS_{R}.i in accordance with

DS_{R}.i=DS_{R}. (i−1)+TI.i

is formed, which, if appropriate, is transmitted by the transfer unit 24.i to the car control device 14.i+1 arranged downstream in the transfer direction Ü_{R}.

The extended data set DS_{R}.i accordingly corresponds to the sum:

DS_{R}.i=Σⱼ₌₁ to ᵢTI.j

For said car control device 14.i—relative to the left transfer direction Ü_{L}—the data set DS_{R}.i received by the corresponding transfer unit 24.i is extended with the sub-information item TI.i. In this case, an extended data set DS_{L}.(i−1) in accordance with

DS_{L}. (i−1)=TI.i+DS_{L}.i

is formed, which, if appropriate, is transmitted by the transfer unit 24′.i to the car control device 14.i−1 arranged downstream in the transfer direction Ü_{L}.

The data set DS_{L}.i accordingly corresponds to the sum:

DS_{L}.i=Σⱼ₌ᵢ₊₁ to _{N} TI.j

where N corresponds to the number of car control devices 14 in the chains.

By means of this formation of cumulative data chains K_{L} and K_{R}, the global information GI can be formed from the data flows exchanged in the data chains K_{L} and K_{R} between two adjacent car control devices 14. For a given value of the index i between 1 and N-1, denoting a pair of car control devices 14.i and 14.i+1 formed by means of the connection segment 22.i, the data sets DS_{R}.i and DS_{L}.i exchanged between said car control devices can be detected. The global information GI can be formed by summation of said data sets:

DS_{R}. i+DS_{L}.i=Σⱼ₌ᵢ to _{N} TI.j=GI

The data sets DS_{R}.i and DS_{L}.i are complementary with regard to the formation of the global information.

The data sets DS_{R}.i and DS_{L}.i can be detected at an arbitrary location in the corresponding connection segment 22.i. They can additionally be detected—as illustrated in the figure—within one of the car control devices 14.i and 14.i+1. For this purpose, the car control devices 14.i are in each case assigned at least one determining unit 28.i and 28′.i, respectively. By way of example, the transfer units 24.i and 24′.i of a car control device 14.i are in each case assigned a determining unit 28.i and 28′.i, respectively. The determining unit 28.i detects the data set DS_{R}.i transmitted by the transfer unit 24.i and/or available for transmission and the data set DS_{R}.i received by the transfer unit 24.i. The determining unit 28′.i detects the data set DS_{L}.(i−1) transmitted by the transfer unit 24′.i and/or available for transmission and the data set DS_{R}.(i−1) received by the transfer unit 24′.i. By way of example, the determining unit 28.2 detects in the right data chain K_{R} the data set DS_{R}.2 corresponding to the sum of the sub-information items TI.1=0 and TI.2=50, and in the left data chain K_{L} the data set DS_{L}.2 corresponding to the sum of the sub-information items TI.4=0 and TI.3=50. The determining unit 28′.2 detects in the right data chain K_{R} the data set DS_{R}.1 corresponding to the sub-information item TI.1=0, and in the left data chain K_{L} the data set DS_{L}.1 corresponding to the sum of the sub-information items TI.4=0, TI.3=50 and TI.2=50.

In the embodiment under consideration, the data sets DS_{R}.i and DS_{R}.i are detected within a car control device 14.i. Alternatively or additionally it is conceivable for the data flows of the left and right data chains K_{L}, and K_{R} to be detected outside a car control device 14 and accordingly along an assigned connection segment 22.i or 22.i−1.

In the drawings, the detection units 28, 28′ are illustrated in each case as units separate from the car control devices 14. However, the detection units 28, 28′ can be in each case a constituent part of the assigned car control device 14.

The car control devices 14.i are in each case connected to at least one determining unit 28.i and/or 28′.i, the connection serving to make available the global information GI for the assigned car control device. For the sake of clarity, the determining units 28.i and 28′.i are illustrated as separate from the corresponding car control device 14.i. They can be embodied separately from the latter or form a constituent part thereof. In an alternative embodiment, it is conceivable for a car control device 14.i to be assigned only one determining unit 28.i or for only one determining unit 28 to be provided for the entire arrangement of car control devices 14.

At least one of the car control devices 14 is provided for implementing, on the basis of the global information formed by means of at least one determining unit 28, a vehicle-wide function which is implemented by the central control apparatus 16 in a normal operating mode. Said function is implemented upon the implementation of a special operating mode initiated by the identification of faulty operation or a complete failure of the central control apparatus 16. For this purpose, the at least one car control device 14 for implementing the vehicle-wide function is equipped with corresponding software. In the exemplary embodiment under consideration, each car control device 14.i is equipped for implementing the vehicle-wide function in the special operating mode. By virtue of the fact that each car control device 14.2, 14.3 of the central cars 12.2, 12.3 are in each case assigned two different determining units 28.i and 28′.i, it is possible to achieve an advantageous redundancy in the formation of the global information GI.

In the application explained with reference to FIG. 2, no direct data exchange takes place between the car control devices 14.1 and 14.4 of the end cars 12.1 and 12.2. In this case, the car control devices 14.1 and 14.4 form the ends of the data chains K_{R} and K_{L}.

FIG. 3 shows the arrangement of the car control devices 14.1 to 14.4 in a further application, in which one of the car control devices 14.2, 14.3 which are arranged in a central car 12.2 and 12.3, respectively, and are accordingly situated within the data chains K_{L} and K_{R} is not functional. As a result, said data chains K_{L} and K_{R} are interrupted. In order to provide data chains K_{L}′ and K_{R}′, an effective data connection between the car control devices 14.1 and 14.4 via the connection segment 22.4 is activated (also see FIG. 1). The above description is correspondingly applicable, the ends of the chains now being formed by the car control devices 14.1 and 14.3 which are situated on both sides of the faulty car control device 14.2. For data exchange between the car control devices 14.1 and 14.4 via the connection segment 22.4, a respective transfer unit 24′.1 and 24.4 is activated for both car control devices 14.1 and 14.4, these transfer units 24′.1 and 24.4 being connected to one another by means the connection segment 22.4. Furthermore, a respective data processing unit 26.1 and 26.4 is activated for both car control devices 14.1 and 14.4. Furthermore, two additional determining units 28′.1 and 28.4 are activated, which are assigned in each case to one of the car control devices 14.1 and 14.4. In particular, the determining unit 28′.1 is assigned to the transfer unit 24′.1 of the car control device 14.1, while the determining unit 28.4 is assigned to the transfer unit 24.4 of the car control device 14.4.

In the exemplary embodiment under consideration, TI.1=10, TI.3=30 and TI.4=40 hold true. The global information GI accordingly corresponds to GI=80.

With regard to the functioning of the data chains K_{R}′ and K_{L}′ formed and the formation of the global information GI on the basis of the data sets exchanged between two adjacent car control devices 14, in order to avoid unnecessary repetitions, reference is made to the description above.

1-10. (canceled)

11. A control system for a rail vehicle with a plurality of cars, the control system comprising:
at least one central control apparatus configured for controlling at least one vehicle-wide function based on global information;
a set of decentralized car control devices which, during operation, each contain a local sub-information item of the global information;
a data connection device having connection segments connecting car control devices of adjacent cars to one another in pairs of car control devices for producing a data transfer in at least one transfer direction;
said paired car control devices and said connection segments form, in the at least one transfer direction, a data chain that is cumulative with respect to the sub-information items; and
at least one determining unit configured to detect and evaluate data of the data chain for forming the global information.

12. The control system according to claim 11, wherein:
said data connection device is configured to produce a data transfer in a right transfer direction and a left transfer direction for each said connection segment;
said paired car control devices and said connection segments form, in the right transfer direction, a right data chain that is cumulative with respect to the sub-information items, and, in the left transfer direction, a left data chain that is cumulative with respect to the sub-information items; and
said determining unit is configured for detecting and evaluating data sets, which are transferred in the right and left transfer directions between two paired car control devices.

13. The control system according to claim 12, wherein said at least one determining unit is at least partly a constituent part of one of said car control devices.

14. The control system according to claim 11, wherein at least one of said car control devices is configured for implementing the vehicle-wide function based on the global information formed by way of said determining unit.

15. The control system according to claim 14, which comprises a set with a plurality of the car control devices each configured for implementing the vehicle-wide function.

16. The control system according to claim 15, wherein said determining unit is one of a plurality of determining units each assigned to a different said car control device of said set.

17. The control system according to claim 11, wherein said data connection device is configured to network said car control devices with one another in a ring-shaped topology.

18. The control system according to claim 11, which comprises a vehicle data bus connecting said car control devices and said central control apparatus to one another, wherein said data connection device is different from said vehicle data bus.

19. The control system according to claim 11, wherein said determining unit is configured for forming a sum of information items contained in data detected thereby.

20. A method of controlling a rail vehicle which has a plurality of cars at least one central control apparatus for controlling at least one vehicle-wide function on the basis of global information, and a set of decentralized car control devices which, during operation, each contains a local sub-information item of the global information, the method comprising:
connecting car control devices of adjacent cars to one another in pairs by way of connection segments of a data connection device;
effecting a data transfer for each connection segment between the car control devices paired by the connection segment in at least one transfer direction;
wherein the paired car control devices and the connection segments form, in the transfer direction, a data chain, which is cumulative with respect to the sub-information items; and
detecting and evaluating data of the data chain and forming the global information on the basis of the data.
